(19) United States
(12) Patent Application Publication
(10) Pub. No.: US 2008/0254762 A1
(43) Pub. Date: Oct. 16, 2008

(54) METHOD AND APPARATUS FOR CALL PROTECTION OVER A TELEPHONE SYSTEM

(75) Inventor: Jacob Igval, Newtown, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/735,142

(22) Filed: Apr. 13, 2007

(51) Int. Cl. H04M 11/04

(52) U.S. Cl. 455/404.1

(57) ABSTRACT

Embodiments of the invention generally provide a method and apparatus for call protection over a telephone system. One embodiment of a method for protecting a telephone call between a first user and a second user includes receiving a request from the first user to protect the telephone call, monitoring wireless communications between a telephone base and a first handset in use by the first user for the presence of a third user, where the third user is attempting to communicate with the telephone base using a second handset after the request for protection has been made, and blocking communications between the second handset and the telephone base.

### FIELD OF THE INVENTION

The present invention generally relates to telecommunications, and more particularly relates to protecting communications over telephone systems.

### BACKGROUND OF THE INVENTION

Recent years have seen an increased emphasis placed on the integrity of private and/or secure communications, which may be compromised in a number of ways.

FIG. 1 depicts an exemplary telephone network 100 in which multiple telephone handsets 102₁-102ₙ are wirelessly connected to the same telephone base 108 via an antenna 109 on the telephone base 108 (e.g., a telephone base may support a plurality of handsets 102). The telephone base 108 connects to a telephone line 104, either by direct connection (e.g., in the case of a public switched telephone network or PSTN arrangement) or through a media terminal adaptor (MTA, e.g., in the case of a voice over Internet Protocol or VoIP arrangement). Since the telephone base 108 communicates with a plurality of handsets 102, each handset 102 typically receives the same communications from the telephone base 108. As a result, each handset 102 may participate in a telephone call between any one handset 102 (e.g., handset 102₁) and another party (e.g., party 106). Accordingly, this arrangement destroys the privacy of the conversation between the two parties.

Therefore, there is a need in the art for a method and apparatus for call protection over a telephone system using a shared telephone base.

### SUMMARY OF THE INVENTION

Embodiments of the invention generally provide a method and apparatus for call protection over a telephone system. One embodiment of a method for protecting a telephone call between a first user and a second user includes receiving a request from the first user to protect the telephone call, monitoring wireless communications between a telephone base and a first handset in use by the first user for the presence of a third user, where the third user is attempting to communicate with the telephone base using a second handset after the request for protection has been made, and blocking communications between the second handset and the telephone base.

In another embodiment, the invention is a computer readable medium containing an executable program for protecting a telephone call between a first user and a second user, where the program performs the steps of: receiving a request from the first user to protect the telephone call, monitoring wireless communications between a telephone base and a first handset in use by the first user for the presence of a third user, where the third user is attempting to communicate with the telephone base using a second handset after the request for protection has been made, and blocking communications between the second handset and the telephone base.

In another embodiment, a telephone base for protecting a telephone call between a first user and a second user includes a receiver for receiving a request from the first user to protect the telephone call and a processor for monitoring wireless communications between the telephone base and a first handset in use by the first user for the presence of a third user, where the third user is attempting to communicate with the telephone base using a second handset after the request for protection has been made, and wherein the processor blocks communications between the second handset and the telephone base.

In another embodiment, In another embodiment, a telephone handset for protecting a telephone call between a first user and a second user includes a transmitter for transmitting wireless communications to a telephone base, a receiver for receiving wireless communications from the telephone base, and a user interface for signaling a request to the telephone base, the request requesting that the telephone base protect the telephone call from any subsequent users attempting to communicate with the telephone base after the request for protection has been made.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an exemplary telephone network;

FIG. 2 is a flow diagram illustrating one embodiment of a method for protecting a telephone call, according to the present invention;

FIG. 3 is a flow diagram illustrating a second embodiment of a method for protecting a telephone call, according to the present invention;

FIG. 4 is a high level block diagram of one embodiment of a system for protecting a telephone call, according to the present invention; and

FIG. 5 is a high level block diagram of a second embodiment of a system for protecting a telephone call, according to the present invention.

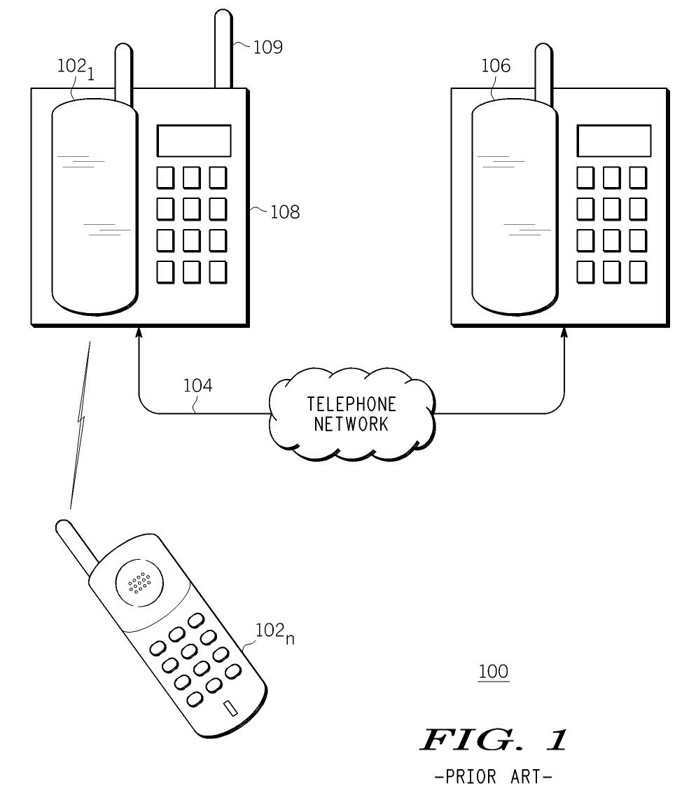

To facilitate understanding, identical reference numerals have been used, where possible, to designate identical elements that are common to the figures.

### DETAILED DESCRIPTION

Embodiments of the invention generally provide a method and apparatus for call protection over a telephone system. In one embodiment, a user may designate a telephone conversation as “private” or “secure”, thereby triggering a mechanism that prevents uninvited parties from eavesdropping on the subsequent conversation. A private communication is one that prevents additional telephone handsets that communicate with a common base station from joining a call in which a first one of the handsets participates. Secure communications, on the other hand rely on encryption or scrambling techniques to protect call signaling and call media flow between a telephone handset and a central call hub. Embodiments of the present invention may be implemented, for example, in accordance with embedded multimedia terminal adapters (eMTAs) with integrated cordless telephone systems.

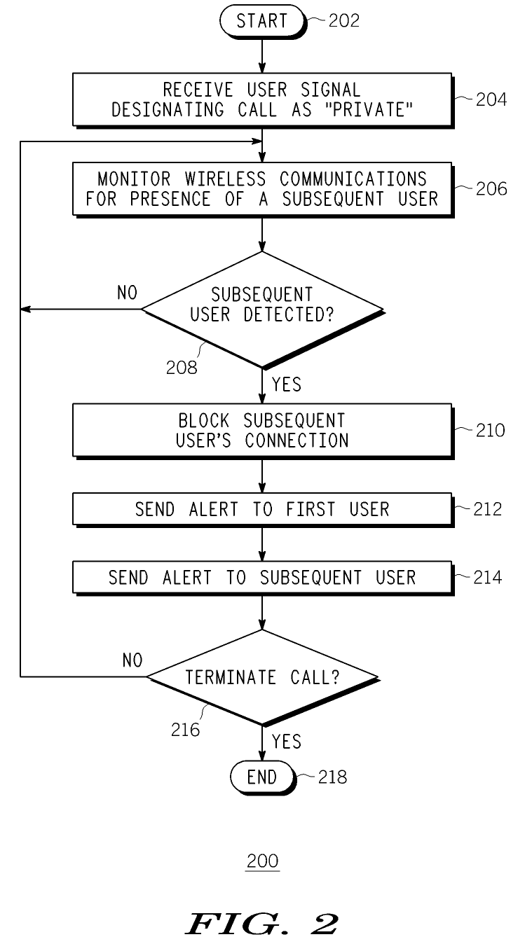

FIG. 2 is a flow diagram illustrating one embodiment of a method 200 for protecting a telephone call, according to the present invention. Specifically, the method 200 enables a telephone call between a first user and a second user to be designated as “private”. The method 200 may be implemented, for example, at a telephone base. In one embodiment, a telephone base comprises at least one of: a cordless telephone base station, a multimedia terminal adapter (MTA), an analog telephony adapter (ATA), a network interface device (NID), an intelligent network interface device (iNID), a wired or wireless gateway, a private branch exchange (PBX) system or any other device that acts as a central hub for all telephone handsets or telephone calls connected on the same telephone line.

The method 200 is initialized at step 202 and proceeds to step 204, where the telephone system receives a signal from the first user indicating that the user wishes to designate the telephone call as a “private” call. The first user may be the user who initiated the telephone call (i.e., the caller) or the user who first responded to the telephone call on the receiving side (i.e., the callee). In one embodiment, the private signal from the first user is indicated by the press of a button (e.g., the first user pressing a button marked “private” on his/her telephone keypad). In another embodiment, the private signal from the first user is indicated by the selection of a menu option (e.g., the first user selecting “private” from a menu of call options such as “hold”, “mute”, etc. on his/her telephone display screen). In yet another embodiment, the private signal from the first user is indicated by the entry of a code (e.g., the first user inputting a designated sequence of numerals on his/her telephone keypad).

In step 206, the telephone base monitors wireless communications between the telephone base and the first user's handset for the presence of a subsequent user (i.e., a user who attempts to participate in the telephone call for example by picking up another handset, after the first user has sent the signal designating the telephone call as “private”). In one embodiment, the telephone base monitors the wireless communications by listening for other telephone handsets (i.e., other than the handset being used by the first user) going off hook on the first user's telephone line. In one embodiment, this may be determined by monitoring line voltage and current on the first user's telephone line (when a subsequent handset connected to the eMTA (with which the telephone base may be associated) via twisted pair wire goes off-hook, the eMTA will detect a voltage drop). In another embodiment, the telephone base monitors the wireless communications by listening for connection messages (e.g., between the base station and a wireless handset, or between wired or wireless handsets) on the telephone line. In a cordless telephone system in accordance with an embodiment of the present invention, each handset registers to the telephone base and is assigned an ID. To join a call, a handset then negotiates an open wireless channel (time division multiple access or TDMA slot) with the telephone base using the handset's ID and a handshake protocol. The telephone base maintains a table of handset IDs. When a call is designated as private (i.e., “locked”) by a handset, the telephone base can prevent any other handset from joining the call by denying access to a wireless channel.

In step 208, the telephone base determines whether a subsequent user has been detected attempting to join the call. If the telephone base concludes in step 208 that a subsequent user has not been detected, the telephone base returns to step 206 and continues to monitor for subsequent connections to the telephone base by other handsets.

Alternatively, if the telephone base concludes in step 208 that a subsequent user has been detected attempting to join the call, the telephone base proceeds to step 210 and blocks the subsequent user's connection to the telephone base. Accordingly, the telephone base blocks the subsequent handset from joining the call.

In step 212, the telephone base may also alert the first user (e.g., via an audio and/or visual indicator) to the attempt by the subsequent user to join the telephone call. Similarly, in step 214 (illustrated in phantom), the telephone base may alert the subsequent user (e.g., via an audio and/or visual indicator) to the fact that the telephone call currently in progress is private.

In step 216, the telephone base determines whether to terminate the private call. This determination may be made, for example, in response to a signal from the first user. In one embodiment, the signal indicating termination of the private call may be received in any of the same manners in which the signal initiating the private call (i.e., received in step 204) is received.

If the telephone base concludes in step 216 that the private call should be terminated, the method 200 terminates in step 218. Alternatively, if the telephone base concludes in step 216 that the private call should not be terminated, the telephone base returns to step 206 and continues to monitor the wireless communications, at least for the duration of the current telephone call.

The method 200 thereby allows a party to a telephone call to designate when his or her communication should be “locked” so as to prevent users of other devices connected to the telephone base to participate in or eavesdrop on the call. The communication may be “unlocked” (that is, the “private” call subsequently designated as “non-private”) at any time during the telephone call. In this way, the party may selectively designate the telephone call or only portions thereof as a “private”.

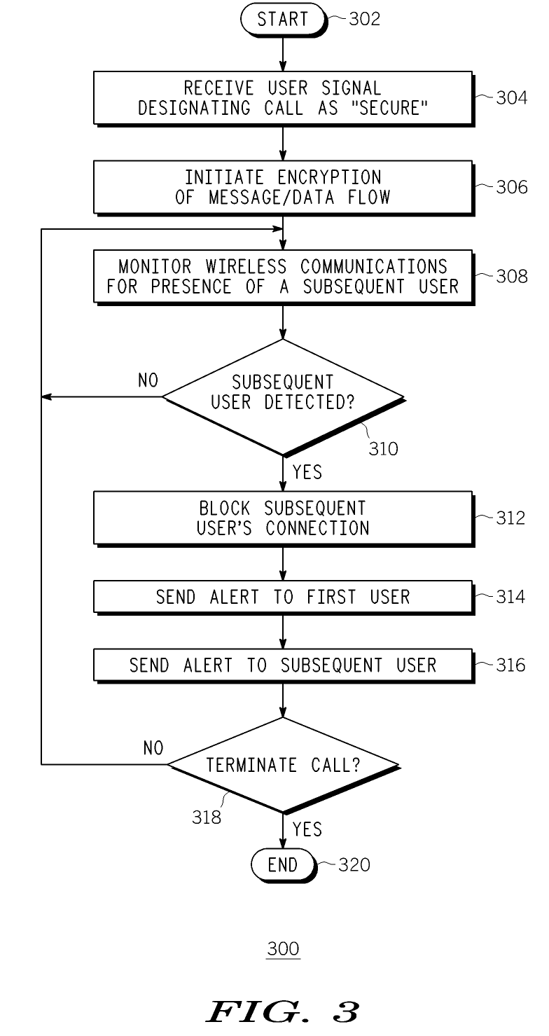

FIG. 3 is a flow diagram illustrating a second embodiment of a method 300 for protecting a telephone call, according to the present invention. Specifically, the method 300 is a variation of the method 200 that enables a telephone call between a first user and a second user to be designated as “secure”. The method 300 may be implemented, for example, at a telephone base. In one embodiment, a telephone base comprises at least one of: a cordless telephone base station, a multimedia terminal adapter (MTA), an analog telephony adapter (ATA), a network interface device (NID), an intelligent network interface device (iNID), a wired or wireless gateway or any other device that acts as a central hub for all telephone handsets or telephone calls connected on the same telephone line.

The method 300 is initialized at step 302 and proceeds to step 304, where the telephone system receives a signal from the first user indicating that the user wishes to designate the telephone call as a “secure” call. The first user may be the user who initiated the telephone call (i.e., the caller) or the user who first responded to the telephone call on the receiving side (i.e., the callee). In one embodiment, the signal from the first user is indicated by the press of a button (e.g., the first user pressing a button marked “secure” on his/her telephone keypad). In another embodiment, the signal from the first user is indicated by the selection of a menu option (e.g., the first user selecting “secure” from a menu of call options such as “hold”, “mute”, etc. on his/her telephone display screen). In yet another embodiment, the signal from the first user is indicated by the entry of a code (e.g., the first user inputting a designated sequence of numerals on his/her telephone keypad).

In step 306, the telephone base initiates encryption of message and data flow. In one embodiment, the telephone base encrypts all message and data flow between the first user's telephone handset and the telephone base. In another embodiment, the telephone base encrypts all message and data flow between the first user's telephone handset and the second user's telephone handset. In one embodiment, the message and data flow is encrypted using any one or more known encryption protocols and/or key exchange algorithms.

In step 308, the telephone base monitors wireless communications between the first user's handset and the telephone base for the presence of a subsequent user (i.e., a user who attempts to participate in the telephone call, for example by picking up another handset, after the first user has sent the signal designating the telephone call as “secure”). In one embodiment, the telephone base monitors the wireless communications by listening for other telephone handsets (i.e., other than the handset being used by the first user) going off hook on the first user's telephone line. In one embodiment, this may be determined by monitoring line voltage on the first user's telephone line. In another embodiment, the telephone base monitors the wireless communications by listening for connection messages (e.g., between a base station and a cordless handset, or between wired or wireless handsets) on the telephone line.

In step 310, the telephone base determines whether a subsequent user has been detected attempting to join the call. If the telephone base concludes in step 310 that a subsequent user has not been detected on the first user's telephone line, the telephone base returns to step 308 and continues to monitor for subsequent connections to the telephone base by other handsets.

Alternatively, if the telephone base concludes in step 310 that a subsequent user has been detected attempting to join the call, the telephone base proceeds to step 312 and blocks the subsequent user's connection to the telephone base. Accordingly, the telephone base blocks the subsequent handset from joining the call.

In step 314, the telephone base may also alert the first user (e.g., via an audio and/or visual indicator) to the attempt by the subsequent user to join the telephone call. Similarly, in step 316, the telephone base may alert the subsequent user (e.g., via an audio and/or visual indicator) to the fact that the telephone call currently in progress is secure.

In step 318, the telephone base determines whether to terminate the secure call. This determination may be made, for example, in response to a signal from the first user. In one embodiment, the signal indicating termination of the secure call may be received in any of the same manners in which the signal initiating the secure call (i.e., received in step 304) is received.

If the telephone base concludes in step 318 that the secure call should be terminated, the method 300 terminates in step 320. Alternatively, if the telephone base concludes in step 318 that the secure call should not be terminated, the telephone base returns to step 308 and continues to monitor the wireless communications, at least for the duration of the current telephone call.

The method 300 thereby allows a party to a telephone call to designate when his or her communications should be “secured” so as to prevent users of other devices connected to the telephone base intercept the communications. The communications may be “unsecured” (that is, the “secure” call subsequently designated as “non-secure”) at any time during the telephone call. In this way, the party may selectively designate the telephone call or only portions thereof as a “secure”.

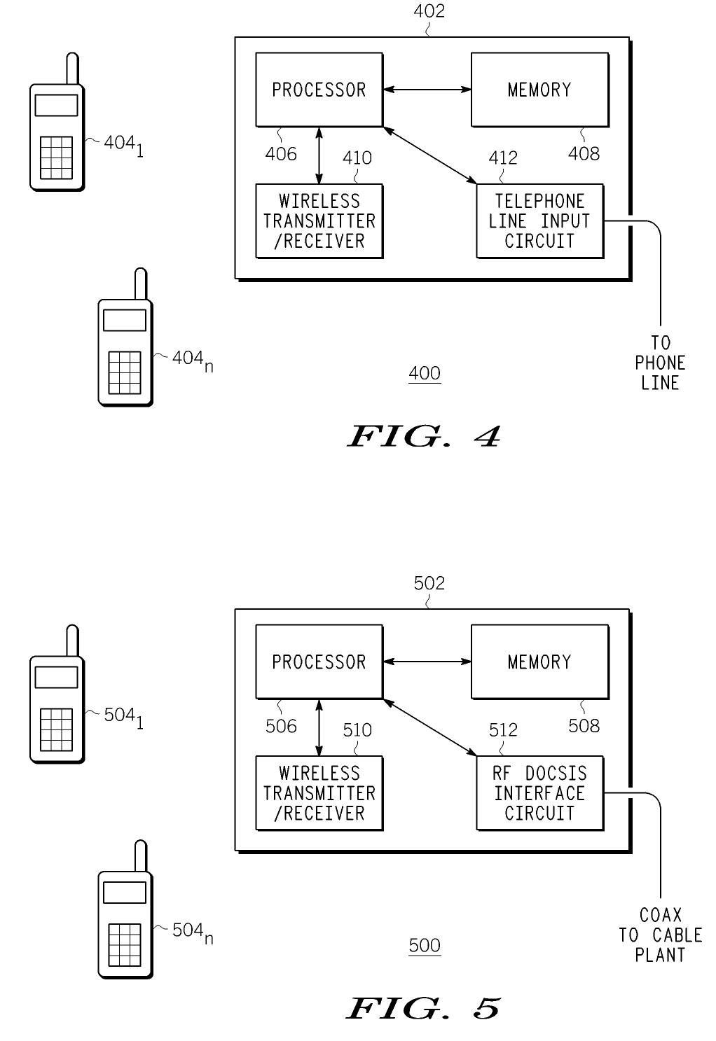

FIG. 4 is a high level block diagram of one embodiment of a system 400 for protecting a telephone call, according to the present invention. As illustrated the system 400 comprises a telephone base 402 and a plurality of telephone handsets 404₁-404ₙ (hereinafter collectively referred to as “handsets 404”) that communicate wirelessly with the telephone base.

In one embodiment, the telephone base 402 comprises at least one of: a cordless telephone base station, a multimedia terminal adapter (MTA), an analog telephony adapter (ATA), a network interface device (NID), an intelligent network interface device (iNID), a wired or wireless gateway, a private branch exchange (PBX) system or any other device that acts as a central hub for all handsets 404 or telephone calls connected on the same telephone line.

In one embodiment, the telephone base 402 comprises a processor 406, a memory 408, a wireless transmitter/receiver 410 and a telephone line input circuit 412. The methods 200 and 300 described above can be represented by one or more software applications (or even a combination of software and hardware, e.g., using Filed-Programmable Gate Array (FPGA)), where the software is operated by the processor 406 in the memory 408 of the telephone base 402. Thus, in one embodiment, the methods 200 and 300 for protecting telephone communications described herein with reference to the preceding figures can be stored on a computer readable medium or carrier (e.g., RAM, magnetic or optical drive or diskette, and the like).

FIG. 5 is a high level block diagram of a second embodiment of a system 500 for protecting a telephone call, according to the present invention. The system 500 is substantially similar to the system 400 illustrated in FIG. 4 and comprises an eMTA 502 and a plurality of telephone handsets 504₁-504ₙ (hereinafter collectively referred to as “handsets 504”) that communicate wirelessly with the eMTA.

In one embodiment, the eMTA 502 comprises an integrated telephone base station. To this end, the eMTA 502 comprises a processor 506, a memory 508, a wireless transmitter/receiver 510 and a radio frequency data over cable service interface specification (DOCSIS) interface circuit 512. Thus, although the system 500 functions in a manner substantially similar to the system 400 illustrated in FIG. 4, the system 500 is capable of supporting telephone calls over a cable system.

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While the foregoing is directed to embodiments of the invention, other and further embodiments of the invention may be devised without departing from the basic scope thereof.

What is claimed is:

1. A method for protecting a telephone call between a first user and a second user, the method comprising:
receiving a request from the first user to protect the telephone call;
monitoring wireless communications between a telephone base and a first handset in use by the first user for the presence of a third user, the third user attempting to communicate with the telephone base using a second handset after the request for protection has been made; and
blocking communications between the second handset and the telephone base.

2. The method of claim 1, wherein the monitoring comprises at least one of:
listening for the second handset going off hook or listening for connection messages from the second handset.

3. The method of claim 1, further comprising:
informing the first user of the third user's attempt to communicate.

4. The method of claim 1, further comprising:
informing the third user that the telephone call is protected.

5. The method of claim 1, wherein the request for protection is a request for a private telephone call.

6. The method of claim 1, wherein the request for protection is a request for a secure telephone call.

7. The method of claim 6, further comprising:
encrypting message and data flow between the first handset and the telephone base.

8. The method of claim 6, further comprising:
encrypting message and data flow between the first handset and a third handset belonging to the second user.

9. A computer readable medium containing an executable program for protecting a telephone call between a first user and a second user, where the program performs the steps of:
receiving a request from the first user to protect the telephone call;
monitoring wireless communications between a telephone base and a first handset in use by the first user for the presence of a third user, the third user attempting to communicate with the telephone base using a second handset after the request for protection has been made; and
blocking communications between the second handset and the telephone base.

10. A telephone base for protecting a telephone call between a first user and a second user, the telephone base comprising:
a receiver for receiving a request from the first user to protect the telephone call; and
a processor for monitoring wireless communications between the telephone base and a first handset in use by the first user for the presence of a third user, the third user attempting to communicate with the telephone base using a second handset after the request for protection has been made,
wherein the processor blocks communications between the second handset and the telephone base.

11. The telephone base of claim 10, wherein the telephone base is at least one of:
a cordless telephone base station, a multimedia terminal adapter, an analog telephony adapter, a network interface device, an intelligent network interface device, a wired gateway, a wireless gateway or a private branch exchange system.

12. The telephone base of claim 10, wherein the processor monitors by listening for the second handset going off hook or

13. The telephone base of claim 10, wherein the processor monitors by listening for connection messages from the second handset.

14. The telephone base of claim 10, further comprising:
a transmitter for informing the first user of the third user's attempt to communicate.

15. The telephone base of claim 10, wherein the processor encrypts message and data flow between the first handset and the telephone base.

16. The telephone base of claim 10, wherein the processor encrypts message and data flow between the first handset and a third handset belonging to the second user.

17. A telephone handset for protecting a telephone call between a first user and a second user, the handset comprising:
a transmitter for transmitting wireless communications to a telephone base;
a receiver for receiving wireless communications from the telephone base; and
a user interface for signaling a request to the telephone base, the request requesting that the telephone base protect the telephone call from a subsequent user attempting to communicate with the telephone base after the request for protection has been made.

18. The telephone handset of claim 17, wherein the request requests that communications between the telephone base and a handset used by the subsequent user be blocked.

19. The telephone handset of claim 17, wherein the user interface comprises one or more buttons on the handset.

20. The telephone handset of claim 17, wherein the user interface comprises a display screen on the handset
